(19) United States
(12) Patent Application Publication
(10) Pub. No.: US 2006/0264123 A1
(43) Pub. Date: Nov. 23, 2006

(54) Wire connector and spacer

(76) Inventor: Paul D. Sergi, Peninsula, OH (US)

Correspondence Address: Edward G. Greive;Renner, Kenner, Greive, Bobak, Taylor & Weber, Fourth Floor, First National Tower, Akron, OH, 44308-1456, US

(21) Appl. No.: 11/338,582

(22) Filed: Jan. 25, 2006

Related U.S. Application Data
(60) Provisional application No. 60/682,674, filed on May 19, 2005.

(51) Int. Cl. H01R 4/48

(52) U.S. Cl. 439/860

(57) ABSTRACT

A connector (10) is provided to connect the wires (21A, 21B and 22A, 22B) of ladder lines (20A, 20B) to each other while maintaining them spaced. The connector (10) is provided with spaced apertures (14, 15) which receive bolts (29). The bolts (29) extend through ring terminals (26A, 26B, 27A, 27B), and the head (30) of each bolt (29) is received in a countersink (16) in the connector (10).

### CROSS-REFERENCE TO RELATED APPLICATION

This application claims the benefit of U.S. Provisional Application No. 60/682,674 filed May 19, 2005.

### TECHNICAL FIELD

This invention relates to a device which is utilized to connect wires, such as ladder line often used in antennas, while at the same time maintaining pairs of the wires spaced.

### BACKGROUND ART

It is often necessary to attach antenna wires, in the form of a ladder line, together when constructing an antenna. Such is particularly helpful in keeping the load impedance as low as possible by attaching lengths of ladder line together, as may be appropriate.

Typically, the ends of the pairs of wires of an antenna ladder line are merely twisted together to attach two lengths of ladder line, and usually the twisted ends are taped to protect them from the elements. But, even under normal weather conditions, the tape could come off or abrade, exposing the wire, and if the line were to be twisted, the wires of the pair may well contact each other, adversely effecting the antenna.

Thus, the need exists to provide a connector between such wires which will maintain them connected and spaced.

### DISCLOSURE OF THE INVENTION

It is thus an object of the present invention to provide a device which can readily be used to connect two wire ends to the ends of two other wires.

It is another object of the present invention to provide a device, as above, which can maintain the two connected wires spaced from each other.

These and other objects of the present invention, as well as the advantages thereof over existing prior art forms, which will become apparent from the description to follow, are accomplished by the improvements hereinafter described and claimed.

In general, a connector is used to connect a first wire of a first ladder line to a first wire of a second ladder line and to connect a second wire of the first ladder line to a second wire of the second ladder line. The connector maintains the first and second wires spaced and includes spaced apertures. A first fastening device is received in one of the apertures to attach the first wires together, and a second fastening device is received in the other aperture to attach the second wires together.

A preferred exemplary connector made according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a perspective view of a connector made in accordance with the present invention.

FIG. 2 is a top plan view showing the connector attaching the two ends of two wires of a ladder line.

FIG. 3 is a bottom plan view of that which is shown in FIG. 2.

FIG. 4 is a fragmentary, exploded perspective view of the components shown in FIG. 3.

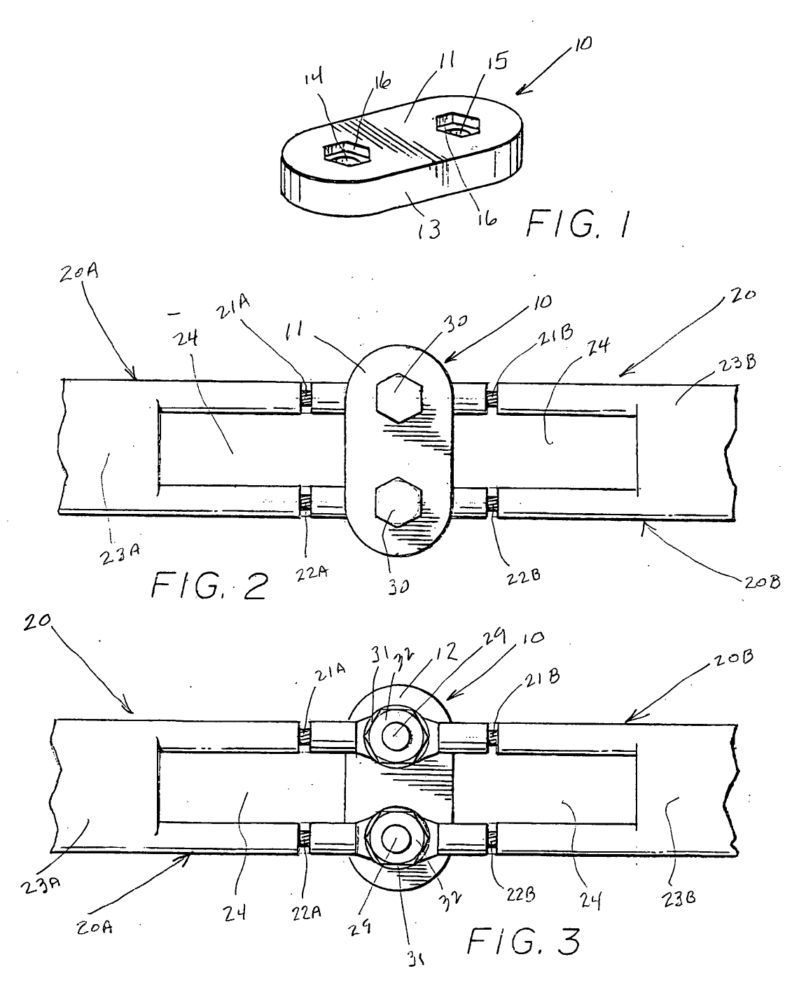

### PREFERRED EMBODIMENT FOR CARRYING OUT THE INVENTION

A connector made in accordance with the present invention is indicated generally by the numeral 10 and is made of any suitable insulating, preferably plastic, material, such as glass filled nylon. Connector 10 includes a body portion having an oval top surface 11 spaced from an oval bottom surface 12 by a side surface 13. Spaced apertures 14, 15 extend through connector 10 from top surface 11 to bottom surface 12. As shown in FIG. 1, apertures 14 and 15 are provided with a hexagonal countersink 16 in top surface 11 which, as will hereinafter be described, assists in the connection of wires to connector 10.

Connector 10 is particularly suited to be used with a ladder line, generally indicated by the numeral 20, and specifically, is used to attach ladder lines 20A and 20B together. As is known in the art, each ladder line 20A, 20B includes a pair of spaced parallel wires 21A, 22A and 21B, 22B, respectively. These wires are maintained spaced by an insulation material 23A, 23B in which the wires 21A, 22A and 21B, 22B, respectively, are encapsulated. Most ladder lines have a plurality of longitudinally spaced windows 24 positioned therein where the insulation material 23A, 23B is only covering the wires.

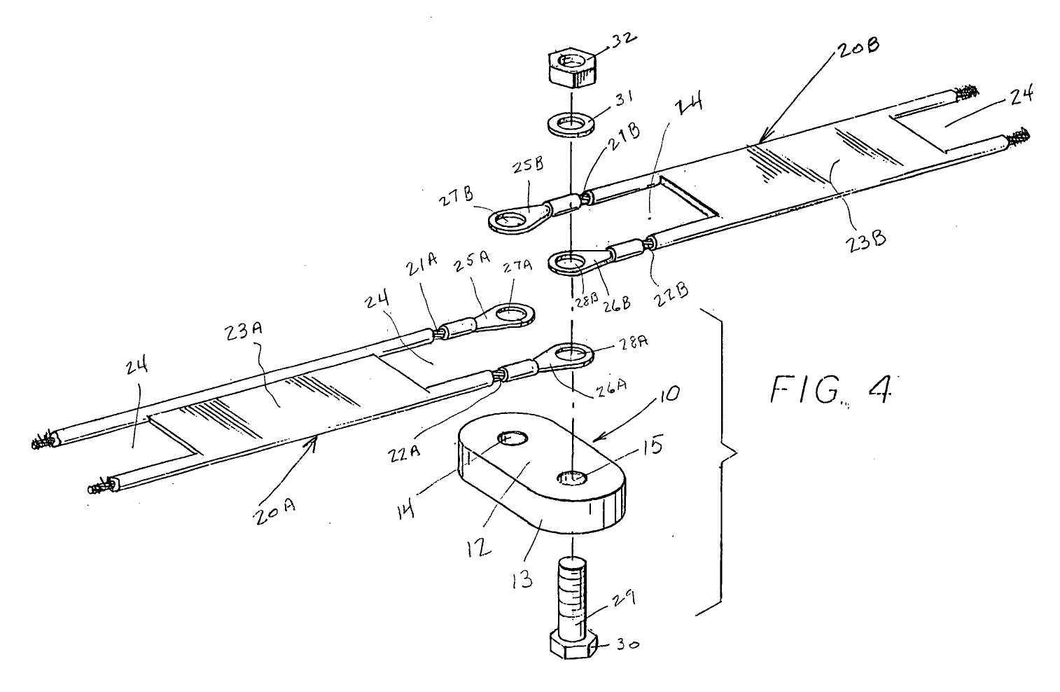

As best shown in FIG. 4, when the ends of the wires of two ladder lines 20A and 20B need to be connected, ring terminals 25A, 26A, 25B and 26B are first connected to wires 21A, 22A, 21B and 22B, respectively. Each ring terminal 25A, 26A, 25B, 26B includes an opening 27A, 28A, 27B, 28B, respectively. To attach ladder lines 20A and 20B together, openings 28A and 28B of ring terminals 26A and 26B, respectively, are aligned with aperture 15 in connector 10. Then a fastening device such as a bolt 29, preferably having a hex-head 30, may be passed through aperture 15 and openings 28A and 28B. A washer 31 may be placed over the shaft of bolt 29, and a nut 32 is tightened on the shaft of bolt 29, thereby attaching wires 22A and 22B to each other and to connector 10. It should be noted that the hex-head 30 of bolt 29 will conveniently be received in countersink 16 of top surface 11 of connector 10 which holds bolt 29 in place while tightening nut 32. Of course, head 30 and countersink 16 need not be hexagonally-shaped, but could take on other configurations such as square or the like, as long as the two configurations match.

Wires 21A and 21B may be similarly connected by aligning openings 27A and 27B of ring terminals 25A and 25B with each other, respectively, and with aperture 14 in connector 10. Then a bolt, washer and nut, like bolt 29, washer 31 and nut 32, can be utilized to attach wires 21A and 21B to each other and to connector 10.

When so assembled, not only are wires 21A and 21B, and wires 22A and 22B attached to each other, but also wires 21 are maintained spaced from wires 22 at their connection points by connector 10. Thus, a system as described herein accomplishes the objects of the present invention and substantially improves the art.

1. A system for connecting a first wire of a first ladder line to a first wire of a second ladder line, and for connecting a second wire of the first ladder line to a second wire of the second ladder line, while maintaining the first and second wires spaced, comprising a connector, spaced apertures in said connector, a first fastening device received in one aperture to attach the first wires together, and a second fastening device received in the other aperture to attach the second wires together.

2. The system of claim 1 further comprising a ring terminal connected to each wire, said first fastening device extending through said ring terminals on the first wires, and said second fastening devices extending through said ring terminals on said second wires.

3. The system of claim 1 wherein each fastening device includes a bolt having a head.

4. The system of claim 3 further comprising a countersink in a surface of said connector aligned with each said aperture, said countersinks being configured to match and receive said heads of said bolts.

5. The system of claim 1 wherein said connector is made of an insulation material.

6. In combination, a first ladder line having a first wire and a second wire, a second ladder line having a first wire and a second wire; and a connector, said connector including spaced apertures, a first fastening device received in one aperture to attach the first wire of the first ladder line to the first wire of the second ladder line, and a second fastening device received in the other aperture to attach the second wire of the first ladder line to the second wire of the second ladder line, said connector maintaining the first and second wires spaced.
